(19) United States
(12) Patent Application Publication
(10) Pub. No.: US 2006/0058199 A1
(43) Pub. Date: Mar. 16, 2006

(54) Oil recovery composition and method using arylalkyl sulfonate surfactants derived from broad distribution aplha-olefins

(76) Inventors: Paul Daniel Berger, Sugar Land, TX (US); Christie Huimin Berger, Sugar Land, TX (US)

Correspondence Address: PAUL D. BERGER;c/o OIL CHEM TECHNOLOGIES, INC., 13013 JESS PIRTLE BLVD, SUGAR LAND, TX, 77478, US

(21) Appl. No.: 10/939,728

(22) Filed: Sep. 13, 2004

(51) Int. Cl. C09K 8/584; E21B 43/00

(52) U.S. Cl. 507/259

(57) ABSTRACT

An oil recovery method is disclosed which uses injection fluids containing a particular class of arylalkyl sulfonate surfactants that are derived from an alpha-olefin stream having a broad distribution of carbon numbers ranging from more than 10 to greater than 30. The alpha-olefin stream is reacted with sulfur trioxide to form the olefin sulfonic acids, and then these are reacted with aromatic feedstock, such as benzene, toluene, xylene, ethylbenzene, phenol, substituted phenol, naphthalene or substituted naphthalene, or a mixture thereof, and neutralized to form arylalkyl sulfonate surfactants. The resulting surfactants have high solubility in a wide range of brines and provide ultra low interfacial tension with crude oils. The resulting surfactants also have economical advantages over the conventional alkylaryl sulfonate surfactants derived from a broad distribution of alpha-olefin stream due to the elimination of the costly alkylation process and the toxic catalyst used in the process.

### FIELD OF INVENTION

The present invention is directed to enhanced oil recovery (EOR). More specifically, the present invention is directed to the composition and method of recovering crude oil from subterranean hydrocarbon containing formations using arylalkyl sulfonate surfactants derived from broad distribution alpha-olefins made by first sulfonating with sulfur trioxide, then reacting the resulting alpha-olefin sulfonic acid with aromatic feedstock followed by neutralizing the resulting arylalkyl sulfonic acid.

### BACKGROUND OF THE INVENTION

Alkylaryl sulfonate surfactants, in particular those based on broad distribution olefins, have been suggested for EOR in the past. For example, Angstadt in U.S. Pat. No. 4,682,653 found that alkylaryl sulfonates derived from alpha-olefin mixtures containing from about C₁₂ to C₃₀ carbon atoms and preferably about C₁₄ to C₁₈ carbon atoms were thermally stable and useful in EOR involving steam flooding Angstadt et al. in U.S. Pat. No. 4,743,385 suggests the use of alkylbenzene, alkyltoluene and alkylethylbenzene such as o-, m- or p-xylene derivatives based on C₈₋₂₈ olefins preferably C₁₀-C₁₆ produced by the Shell “SHOP” process and olefins produced by ethylene oligomerization and having 12 to 30 carbons. A hydrotrope is included in the formulations suggested by Angstadt et al. to help solubilize the high molecular weight alkylaryl sulfonate surfactants. Bolsman, in U.S. Pat. No. 4,873,025 also uses the ortho-, para- and meta-alkylxylene sulfonates prepared from alpha-olefin based on C₆ to C₂₀. The para-xylene sulfonates were found to give the best solubilization parameter with the oil/brine systems used. Alkylaryl sulfonate surfactants derived from broad distribution alpha-olefins have also recently been recognized as being promising for EOR by surfactant floods as noted in U.S. Pat. No. 6,269,881. The alkylaryl sulfonate surfactants derived from broad distribution alpha-olefin can be prepared using C₁₀ bottoms from a commercial ethylene synthesis alpha-olefin reactor and do not require the separation of the narrow selections of carbon chain lengths thus reducing the cost. The alkylaryl sulfonate surfactants derived from broad distribution alpha-olefin also provide favorable phase behavior with high wax crude oil and improve the stability of the aqueous surfactant solutions. However, the alkylation process used to prepare the alkylaryl sulfonate surfactants as described in U.S. Pat. Nos. 4,682,653, 4,743,385, 4,873,025 and 6,269,881 is very expensive and often renders the economic justification of the EOR project unfeasible. Additionally, the alkylaryl sulfonate surfactants have limited solubility in high salinity brines.

In commercial applications of surfactant floods, the quantity of surfactant required is extremely large, often exceeding 100 million pounds, and a manufacturing plant dedicated for the project is often necessary. A typical conventional alkylation plant is a major up-front investment. As reported in Handbook of Petroleum Refining Processes page 1.60, an 80,000 metric alkylation plant will cost approximately 72 Million dollars along with annual maintenance costs including labor, utilities and insurance of about $10.56 Million and catalyst cost of about $1.44 Million. The huge up-front cost and re-occurring costs will add on the cost of the project and often reduce the potential or eliminate the EOR method from consideration as a viable means of recovering oil. The alkylation process also requires the use of toxic and hazardous catalyst such as HF or AlCl₃. These need to be disposed of when they become spent and replenished at considerable cost for handling and materials. Also the alkylation reaction requires the use of 5 fold or more equivalents of aromatic per equivalent of olefin to drive the reaction. The excess aromatic must be recovered and recycled resulting in additional costs and the possibility for loss of feedstock through an accidental release into the environment.

Thus it would be highly desirable to have an oil recovery composition and method that includes a sulfonate surfactant derived from a broad distribution of alpha-olefin and that does not require huge up-front investment, does not use hazardous catalyst, does not have high re-occurring maintenance cost and is more environmentally friendly than the current state of the art. In addition it would be highly desirable that such broad distribution sulfonate surfactants are suitable for a wide range of crude oils from waxy crude oil to light crude oil and are tolerant to a wide range of salt concentrations in the injection water

### SUMMARY OF THE INVENTION

The present invention includes a composition and method of recovering crude oil from a subterranean hydrocarbon containing formation which comprises (a) injecting into said formation through one or more injection wells an aqueous solution containing an effective amount of an arylalkyl sulfonate surfactant, prepared by first sulfonating an alpha-olefin stream having a broad distribution in olefin carbon numbers, the olefin stream is the carbon chain C₁₀ bottoms of a commercial alpha-olefin reactor, then reacting the resulting alpha-olefin sulfonic acid with an aromatic compound, wherein the aromatic compound is selected from the group consisting of benzene, toluene, xylene, ethyl benzene, naphthalene, substituted naphthalene, phenol, substituted phenol or mixtures thereof, and then neutralizing the resulting arylalkyl sulfonic acid, and (b) displacing said solution into the formation to recover hydrocarbons from one or more production wells.

### BRIEF DESCRIPTION OF THE FIGURES

FIG. 1 compares the structures of the arylalkyl sulfonates used in this invention with the alkylaryl sulfonates that have been used in the prior art.

FIG. 2 compares the reaction schemes used to produce the two types of sulfonates.

### DETAILED DESCRIPTION OF THE INVENTION

The present invention relates to a composition and method of recovering oil from a subterranean hydrocarbon containing formation by surfactant flooding and addresses the previously cited desirable features and also provides other advantages obvious to the ordinary skilled artisan. The method is especially useful when a high volume surfactant flood is anticipated and economical and environmental issues are essential. The composition and method of this invention involves the inclusion of arylalkyl sulfonates derived from broad-distribution alpha-olefins in aqueous injection fluids that are introduced through one or more injection wells into an oil-bearing subterranean reservoir and are used to reduce the capillary forces trapping the oil thus allowing the oil to be recovered through one or more producing wells.

The present invention of the EOR composition and method of recovering oil using surfactant derived from broad distribution alpha-olefin permits better use of the whole spectrum of an alpha-olefin plant's products. Since the current alpha-olefin market is largely driven by the demand in C₁₀ and lower fractions use in plastic production such as polyethylene and/or polypropylene, the use of C₁₀ bottoms (i.e., greater than C₁₀ and higher fractions of an alpha-olefin process) in the present invention does not pose a conflict or tradeoff. It actually provides for a more synergistic use of the plants total output. In fact, taking the entire C₁₀ bottoms, i.e., C₁₂ and higher, would eliminate many costly fractionation steps, thus further lowering the cost of the alpha-olefin feedstock for the surfactant. Suitable ranges are C₁₂ to C₃₀ or more, preferably ranges such as C₁₂ to C₂₈; and C₁₂ to C₂₄).

Conventional alkyl aryl sulfonate surfactants generally focus on a narrow range of olefin carbon numbers, such as C₁₂ xylene sulfonate, C₁₂ benzene sulfonate, C₁₆ xylene sulfonate, C₁₈ toluene sulfonate, and C₂₀₋₂₄ toluene sulfonate. In these cases, other carbon chain lengths made during the reaction must be separated out. In commercial applications of surfactant floods, the quantity of surfactant required is huge, often exceeding 100 million pounds. If only a narrow fraction of the alpha-olefins are used to make the surfactant, the required olefin plant capacity would exceed a few billion pounds, which is not presently available. While one can build a new plant to meet the demand of the surfactant flood, the unused olefin fractions cannot be readily used for other purposes and, therefore, must be accounted for in the cost of the olefin feedstocks for the surfactant. This adds to the cost of the specifically used product and the volume of the required narrow fraction of the alpha-olefins may not be presently available.

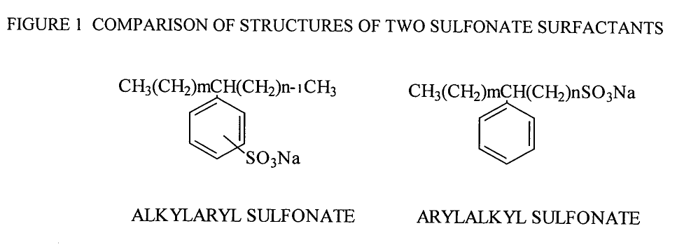

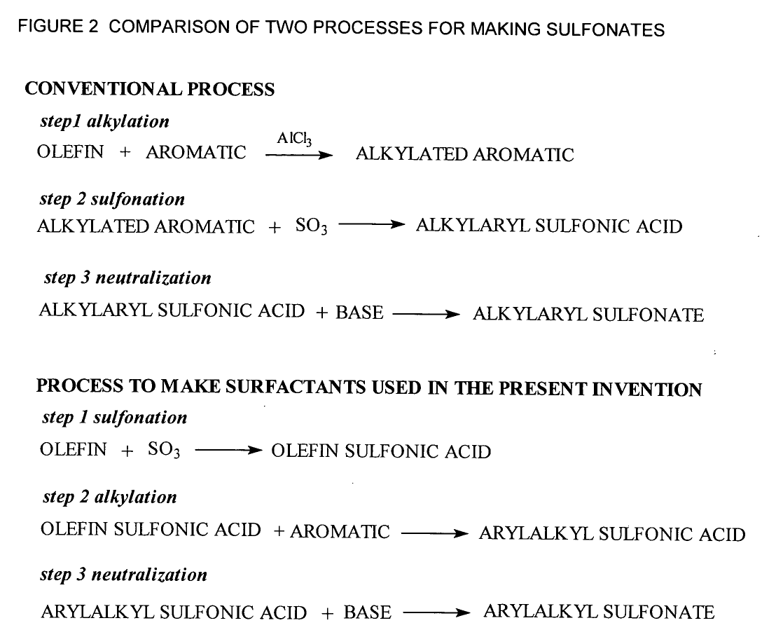

The arylalkyl sulfonate surfactants used in the present invention are derived from a broad distribution of alpha-olefins and are prepared in three steps: sulfonation, alkylation and neutralization. The structure of the resulting arylalkyl sulfonate surfactants and the detailed process are shown in FIGS. 1 and 2. The broad distribution alpha-olefin is first sulfonated in a thin film reactor with SO₃/Air to form the alpha-olefin sulfonic acid. This alpha-olefin sulfonic acid is then reacted with a suitable aromatic compound such as benzene, toluene, xylene, phenol, substituted phenol, naphthalene, substituted naphthalene, or mixtures thereof, to form the arylalkyl sulfonate surfactant using the process as described in U.S. Pat. No. 6,043,391. The use of xylene as the aromatic compound for alkylation is especially preferred because of its higher boiling point that allows it to be handled without pressure during the alkylation process. While not described here, one can certainly use a mixture of any one or more of benzene, ethylbenzene, toluene, xylene, phenol, substituted phenol, naphthalene, substituted naphthalene having various alkyl chains or any of these aromatic compounds individually to optimize the surfactant for a specific reservoir application or to take advantage of the aromatics market conditions.

FIG. 1 compares the structures of the arylalkyl sulfonates of the present invention with the alkylaryl sulfonates that have been used in the prior art. In FIG. 1, m and n are any values chosen such that the total number of carbons on the chain fall within the range of carbons found in the C₁₀ bottoms fraction of a commercial olefin reactor. FIG. 2 compares the reaction schemes used to produce the arylalkyl sulfonate surfactants and the conventional process to prepare the alkylaryl sulfonate surfactants. The arylalkyl sulfonate surfactants derived from the broad distribution alpha-olefins used in the present invention are prepared without the need of a conventional alkylation plant. A typical conventional alkylation plant is a major up-front investment as are on-going maintenance costs and the cost of securing, handling and disposing of hazardous catalyst. These often make an EOR project using alkylaryl sulfonates economically unfeasible. In the present invention, the arylalkyl sulfonate surfactants derived from broad distribution alpha-olefins do not need a separate alkylation plant since the alkylation of the aromatics occurs as the alpha-olefin sulfonic acid leaves the sulfonation unit on its way to the neutralization unit.

The arylalkyl sulfonate surfactant derived from broad distribution alpha-olefins is formulated in an effective amount into an aqueous injection solution in combination with, optionally one or more co-surfactants/solvents and optionally a polymer, and injected into one or more injection wells to allow the recovery of oil from a subterranean hydrocarbon containing formation to one or more producing wells by lowering the IFT between trapped oil and the injection solution. The injection well and the producing well may be the same or different wells or a combination of both. The concentration ranges of the present invention using the arylalkyl sulfonate surfactants derived from broad distribution of alpha-olefins is from 0.025% to 3.0% by weight, preferably 0.1% to 1.0% by weight, and most preferably 0.2% to 0.8% by weight. A cosurfactant/solvent may be included at approximately the same concentration as the surfactant and is usually formulated with the surfactant in a concentrated form that is then diluted with injection water to the appropriate final concentration at the injection site. The co-surfactants/solvents can also be formulated with the arylalkyl sulfonate surfactant prior to the injection. Conventional co-surfactants/solvents for example an alcohol or ether such as Iso-propanol, sec-butanol, ethylene glycol monobutyl ether (EB) or diethylene glycol can be used.

Polymers, such as those commonly employed for such purposes, may be included to control the mobility of the injection solution. Such polymers include, but are not limited to, xanthan gum, partially hydrolyzed polyacrylamides and copolymers of 2-acrylamido-2-methylpropane sulfonic acid and polyacrylamide commonly referred to as AMPS copolymer. Polymers are used in the range of about 500 to about 2000 PPM in order to match or exceed the reservoir oil viscosity under reservoir conditions of temperature and pressure.

The following are examples of specific properties of formulations containing the arylalkyl sulfonate surfactants derived from a broad distribution of alpha-olefins.

A broad distribution alpha-olefin feedstock simulating the commercial ethylene synthesis alpha-olefin reactor C₁₀ bottom was prepared consisting of a mixture of individual alpha-olefins having a carbon chain length of from C₁₂ to C₃₀ obtained from Chevron Chemical Company. The carbon distribution is shown in Table 1.

TABLE 1
Simulated Broad Distribution Alpha-Olefin Feedstock

| Carbon Chain Length | Wt, % |
|---|---|
| C₁₂ | 23 |
| C₁₄ | 18 |
| C₁₆ | 14 |
| C₁₈ | 12 |
| C₂₀ | 9 |
| C₂₂ | 7.5 |
| C₂₄ | 6 |
| C₂₆ | 4.5 |
| C₂₈ | 3.5 |
| C₃₀ | 2.5 |

A broad distribution feedstock simulating the C₁₀ bottoms of an alpha-olefin reactor as shown in Table 1 was reacted with Air/SO₃ to produce the corresponding alpha-olefin sulfonic acid, then reacting the resulting alpha-olefin sulfonic acid with o-xylene followed by neutralizing with aqueous NaOH. This sample is designated as XSA-1230.

The arylalkyl sulfonate surfactant was prepared using a C₁₂₋₂₄ alpha-olefin stream supplied by Chevron Chemical Company reacting with Air/SO₃ to produce the corresponding alpha-olefin sulfonic acid, then reacting the resulting alpha-olefin sulfonic acid with o-xylene followed by neutralizing with aqueous NaOH. This sample is designated as XSA-1224.

An alkylaryl sulfonate surfactant was prepared from the same C₁₂₋₂₄ alpha-olefin stream supplied by Chevron Chemical Company using the conventional method of first alkylating o-xylene with the C₁₂₋₂₄ alpha-olefin using AlCl₃ and subsequently sulfonating with Air/SO₃ and neutralizing with aqueous NaOH. This sample is designated as OXA-1224.

### EXAMPLE 1

A simulated injection fluid was prepared using either 0.5% of the XSA-1230 or the XSA-1224, 0.25% ethylene glycol monobutyl ether, 3.0% NaCl and the remainder water. The IFT of the simulated injection fluid against a waxy crude oil having an API gravity of 18 and also against a light crude oil with API gravity of 30 was determined at 60° C. using the University of Texas Model 500 Spinning Drop Tensiometer.

It is widely known throughout the industry that an IFT value of equal or less than 10⁻² mN/m is necessary to overcome capillary forces trapping oil in microscopic pores within a subterranean reservoir and to recover additional oil by EOR methods as discussed by Morgan et al. in Improved Oil Recovery by Surfactant and Polymer Flooding, p. 102 and Pope in Basic Concepts in Enhanced Oil Recovery, p. 89-90. The results shown in distribution alpha-olefins are very effective in lowering the IFT to the desired ranges with different oils for EOR.

TABLE 2
Interfacial Tension Properties Of Injection Fluids Containing XSA-1230
and XSA-1224

| | Crude oil API Gravity | IFT, mN/m |
|---|---|---|
| XSA-1230 | 18 | 0.0049 |
| XSA-1230 | 30 | 0.0065 |
| XSA-1224 | 18 | 0.0211 |
| XSA-1224 | 30 | 0.0086 |

### EXAMPLE 2

Example 2 compares the solubility of the XSA-1224 and OSA-1224 in various concentrations of salt. The test was run at 60° C. using 0.5% by weight of the surfactant. Table 3 illustrates the solubilities of the surfactants over a wide range of salt concentrations.

TABLE 3
Surfactant Solubilities in Various Concentrations of Salt

| NaCl, % by wt | OSA-1224 | XSA-1224 |
|---|---|---|
| 0.5 | Clear | Clear |
| 1.0 | Clear | Clear |
| 2.0 | Clear | Clear |
| 3.0 | Haze | Clear |
| 5.0 | Precipitate | Clear |
| 10.0 | Precipitate | Haze |

Surprisingly, the board distribution arylalkyl sulfonate surfactants discussed in the present invention illustrates their unexpected benefits by extending their solubility ranges in various concentrations of salt solution over the range obtained using broad distribution alkylaryl sulfonate surfactants made by conventional process. As known to the ordinary skilled artisan, the electrolyte tolerance of a surfactant is very important in EOR since the injection fluid is subject to changes in salinity upon contact with connate water in the oil reservoir and these changes can affect surfactant compatibility and performance. Furthermore, it is often preferred to use the produced brine as the injection brine in order to eliminate the additional costs of treating injection water. The broad electrolyte tolerance of the arylalkyl sulfonate surfactant enables it to be used in a wide range of produced brine without water treatment.

The invention was described with respect to particularly preferred embodiments. Modifications within the scope of the ordinary skilled artisan, i.e. the use of different olefin chain length distributions and the use of various aromatic isomers such as o-, m- or p-xylene or mixtures of these are within the scope of the invention and the appended claims.

What is claimed is:

1. A method of recovering crude oil from a subterranean hydrocarbon containing formation which comprises (a) injecting into said formation through one or more injection wells an aqueous solution containing an effective amount of an arylalkyl sulfonate surfactant, prepared by first sulfonating an alpha-olefin stream having a broad distribution in olefin carbon numbers, the olefin stream is the carbon chain C₁₀ bottoms of a commercial alpha-olefin reactor, then reacting the resulting alpha-olefin sulfonic acid with an aromatic compound, wherein the aromatic compound is selected from the group consisting of benzene, toluene, xylene, ethyl benzene, naphthalene, substituted naphthalene, phenol, substituted phenol or mixtures thereof, then neutralizing the resulting arylalkyl sulfonic acid, and (b) displacing said solution into the formation to recover hydrocarbons from one or more production wells.

2. The method of claim 1 where the arylalkyl sulfonate surfactant is present in amounts from about 0.025% by weight to about 3.0% by weight in the aqueous solution.

3. The method of claim 1 wherein said alpha-olefin stream is a combination of individual alpha-olefin fractions having a carbon chain of from about C₁₂ to about C₃₀.

4. The method according to claim 1 wherein the aromatic compound is o-xylene, m-xylene, p-xylene or mixtures thereof.

5. The method according to claim 1 wherein the injection wells and production wells are selected from the group consisting of the same well, different wells or combinations thereof.

6. The method of claim 1 where the neutralization is carried out using NaOH.

7. A composition for enhanced oil recovery comprising
(a) an arylalkyl sulfonate surfactant made by first sulfonating an alpha-olefin stream having a broad having a broad distribution in olefin carbon numbers, the olefin stream is the carbon chain C₁₀ bottoms of a commercial alpha-olefin reactor, then reacting the resulting alpha-olefin sulfonic acid with an aromatic compound, wherein the aromatic compound is selected from the group consisting of benzene, toluene, xylene, ethyl benzene, naphthalene, substituted naphthalene, phenol, substituted phenol or mixtures thereof, then neutralizing the resulting arylalkyl sulfonic acid,
(b) an aqueous solvent,
(c) optionally a polymer thickening agent and;
(d) optionally a solvent/cosurfactant.

8. The composition according to claim 7 wherein the aryl group is o-xylene, m-xylene, p-xylene, or mixtures thereof.

9. The composition of claim 7 where the arylalkyl sulfonate surfactant is present in amounts from about 0.025% by weight to about 3.0% by weight.

10. The composition of claim 7 wherein said alkyl chain is one having a carbon chain of from about C₁₂ to about C₃₀.

11. The composition of claim 7 where the neutralization is carried out using NaOH.
